(19) United States
(12) Patent Application Publication
(10) Pub. No.: US 2014/0322450 A1
(43) Pub. Date: Oct. 30, 2014

(54) COATING METHOD AND DEVICE OF THE PACKAGING MATERIAL

(71) Applicant: EverDisplay Optronics (Shanghai) Limited, Shanghai (CN)

(72) Inventor: SyueYi Deng, Shanghai (CN)

(73) Assignee: EverDisplay Optronics (Shanghai) Limited, Shanghai (CN)

(21) Appl. No.: 14/262,410

(22) Filed: Apr. 25, 2014

(30) Foreign Application Priority Data
Apr. 26, 2013 (CN) 201310151574.4

(51) Int. Cl. B05C 5/00; B05D 1/02

(52) U.S. Cl. CPC B05C 5/001; B05D 1/02
USPC 427/422; 118/50

(57) ABSTRACT

The present invention relates to a coating method and a coating device of the packaging material, applicable in the packaging process of a substrate. By adopting the melt spraying process for coating the molten packaging material, the steps of drying and sintering in the related art can be omitted. Therefore, the production circle of the whole packaging process can be shortened and the number of production apparatus can be decreased, and, thus, the investment and cost of the apparatus and the maintenance thereof during the production procedure can be decreased.

### CROSS-REFERENCE TO RELATED APPLICATIONS

The present application claims priority to and the benefit of Chinese Patent Application No. CN 201310151574.4, filed on Apr. 26, 2013, the entire content of which is incorporated herein by reference.

### BACKGROUND OF THE INVENTION

1. Field of the Invention

The present invention relates to a packaging process and device, more specifically, to a coating method and device of packaging material.

2. Description of the Related Art

In the displaying screen field, the LCD technology has been replaced by the OLED technology progressively. Engineers in this industry have focused on the improvement of the performance of the displaying screen, and great efforts are given to the designing and the production of the devices. However, by contrast, the enough attention has not paid to the packaging process of the devices.

Actually, in the manufacturing process of the photoelectric devices, the packaging process in the later stage and the processes in the anterior stage are equally important. Because the package can seal a device in a constant condition, preventing the erosion due to pollutant, such as the moisture or oxygen, the stability of the device can be preserved. Therefore, the packaging process for a device after production is an important process which can ensure the performance during using identical with the design level.

Currently, during the whole packaging process, the packaging process comprises the following steps: determining the packaging areas on the glass substrate; coating the glass frit at the edges of the packaging areas; drying and sintering the glass frit successively to complete the packaging process.

Obviously, in the related art, the packaging process of the photoelectric devices at least comprises three steps as coating, drying and sintering. Because of the excessive steps during the actually industry producing process, the productive circle of the product is lengthened, which has been deemed to be a shortage of the producing process of the photoelectric devices. Moreover, the excessive steps will need too many equipments, thus a big cost of money and humane resource is a necessary for the maintenance of the equipments during the daily production, leading to the increase of the cost for manufacturing or producing.

A related art has discloses a method for packaging a photoelectric device, comprising the following steps: fixing a chip on a metal frame by using an adhesive; connecting the chip with a pin on the metal frame by using gold wires; coating a sealant on a bayonet in a preformed outer frame as well as the joint of an upper cover and the preformed outer frame; pushing the upper cover and then installing the upper cover on the preformed outer frame by using the sealant; and sticking one layer of sealing protective film on the upper surface of the upper cover. The related art has improved the protected mode using the glue; however, the steps of the art are relatively complex, which causes the difficulty in applying the art in the mass production.

In another related art, an oxidized copper lead frame and a semiconductor die with copper posts extending from die pads, and with solder balls coated with flux on the end of the copper posts, are provided. The semiconductor die is placed on the oxidized copper lead frame, with the solder balls abutting portions of the layer of oxide, above and aligned with, interconnect locations on the lead frame. When reflowed, the flux on the abutting portions of the oxide layer selectively cleans these portions of the oxide layer, away from the interconnect locations. In addition, the solder balls change to molten state and adhere to the cleaned copper surfaces at the interconnect locations. The related art did not improve the steps of the packaging process.

### SUMMARY OF THE INVENTION

An aspect of an embodiment of the present disclosure is directed toward a coating method of a packaging material capable of reducing the number of the production apparatus in the whole packaging process and lowering the cost of maintenance thereof

Another aspect of an embodiment of the present disclosure is directed toward a coating device applied to the coating method.

An embodiment of the present disclosure provides a coating method of a packaging material, comprising:

providing a substrate with a packaging area;

transforming the packaging material into a molten state in the reaction chamber;

spraying the molten packaging material on the packaging area to form a layer of the packaging material on a surface of the packaging area;

wherein temperature of the packaging material sprayed on the substrate is lower than the melting point of the substrate.

According to one embodiment of the present disclosure, wherein the step of transforming the packaging material into the molten state is performed by a heating step and a pressurizing step in the reaction chamber;

wherein, after the pressurizing step, pressure in the reaction chamber is between 0.2 MPa and 1.2 MPa.

According to one embodiment of the present disclosure, wherein the packaging material is glass powder or a mixture consisted of glass and metal oxide.

According to one embodiment of the present disclosure, when the packaging material is glass powder and the heating step is performed in the reaction chamber, the temperature in the reaction chamber is between 1800° C. and 2200° C.

According to one embodiment of the present disclosure, when the packaging material is the mixture of glass and metal oxide and the heating step is performed in the reaction chamber, the temperature in the reaction chamber is between 700° C. and 1600° C.

According to one embodiment of the present disclosure, wherein the metal oxide is one or more selected from a group consisted of MgO, CaO, BaO, Li₂O, Na₂O, K₂O, B₂O₃, V₂O₅, ZnO, TeO₂, Al₂O₃, SiO₂, PbO, SnO, P₂O₅, Ru₂O, Fe₂O₃, Rb₂O, Rh₂O, CuO, TiO₂, WO₃, Bi₂O₃ and Sb₂O₃.

According to one embodiment of the present disclosure, wherein the thickness of the packaging material layer is between 3 μm and 6 μm.

According to one embodiment of the present disclosure, wherein the substrate is a rigid substrate.

Another embodiment of the present disclosure provides a coating device, comprising:

a reaction chamber for holding the packaging material;
a heating device for increasing the temperature of the environment in the reaction chamber; and

a pressurizing device for increasing the pressure of the environment in the reaction chamber;

wherein, the reaction chamber is provided with a nozzle to spray the molten packaging material formed by the environment changed by the heating device and the pressurizing device onto a substrate to form the packaging material layer.

Another embodiment of the present disclosure provides wherein the reaction chamber comprises:

a feeding inlet for charging the packaging material into the reaction chamber; and

a gas inlet for carrying gas into the reaction chamber to increase the pressure with the aid of the pressurizing device, and the pressurizing device can be a gas booster pump.

Another embodiment of the present disclosure provides wherein the heating device comprises:

a positive electrode and a negative electrode placed in the reaction chamber;

a controller; and

a electric source connected to the positive electrode and negative electrode by the controller to form a closed circuit;

wherein the electric source is controlled by the controller to provide electric current to form an electric arc between the positive electrode and negative electrode, by which the temperature in the reaction chamber is increased.

### BRIEF DESCRIPTIONS OF THE DRAWINGS

The accompanying drawings, together with the specification, illustrate exemplary embodiments of the present disclosure, and, together with the description, serve to explain the principles of the present disclosure.

FIG. 1 is a flow chart of the coating method of the packaging material in the present invention;

FIG. 2 is a side view of the coating device which is used to perform the coating process to the surface of the substrate in Embodiment 3.

### DETAILED DESCRIPTIONS

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

### Embodiment 1

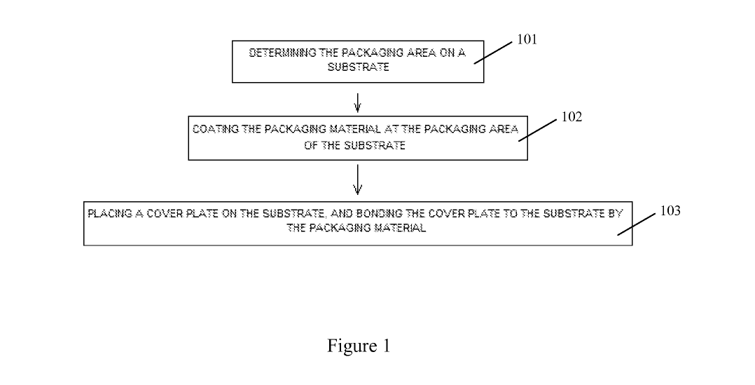

As shown in FIG. 1 which shows a flow chart of the coating method of the packaging material in the present invention. The coating method of the packaging material in the present embodiment comprises the following steps:

101: Determining a packaging area on a substrate, wherein the substrate may be a rigid substrate or flexible substrate, and preferably a rigid substrate, such as glass, metal, or other material selected according to the process or requirement.

102: Coating the packaging material used for packaging on the packaging areas of the surface of the substrate, wherein, the packaging material is coated by a melt spraying process comprising:

S1, heating and pressurizing the packaging material in a reaction chamber to transform the packaging material into the melt state from the solid state;

S2, supplying gas with a certain pressure; with the aid of the pressure, the molten packaging material is sprayed onto the packaging area of the surface of the rigid substrate to form a layer of the packaging material; the temperature of the molten packaging materials sprayed onto the surface of the substrate is controlled to be lower than the melt point of the substrate.

In step of the melt spraying process, it can be any one of the fire melt wire flame spraying process, melt powder flame spraying process, electric arc spraying process, high speed flame spraying process, atmospheric plasma spraying process and pinhole plasma process. The packaging material applicable for the packaging process can be glass powder or the mixture consisted of glass powder and metal oxide, and preferably in this embodiment is the glass powder.

As the packaging material is the glass powder in the present embodiment, in the step of the melt spraying process, the temperature of the glass powder should be controlled between 1800° C. and 2200° C., such as 1900° C., 2000° C. (mostly preferred) and 2100° C.; the pressure applied on the glass powder should be controlled between 0.2 Mpa and 1.2 Mpa, such as 0.3 Mpa, 0.4 Mpa, 0.6 Mpa, 0.7 Mpa and 0.8 Mpa; the pressure of the gas which is introduced into the glass powder should be controlled between 0.2 Mpa and 1.2 Mpa, such as 0.3 Mpa, 0.4 Mpa, 0.6 Mpa, 0.7 Mpa and 0.8 MPa; the thickness of the layer formed from the packaging material is between 3 μm and 6 μm, such as 4 μm and 5 μm.

After finishing the coating process of the packaging material, 103: directing a cover plate at the packaging area of the substrate; bonding the cover plate and the substrate by the molten glass.

In this embodiment, the melt spraying is adopted for coating the packaging material, compared to the process in the related art, the drying process and sintering process can be omitted, in other words, this embodiment combines the three processes in the relate art into one process. Therefore, the process is simplified and the producing time is saved. Meanwhile, the number of the production apparatus is also decreased, the corresponding maintenance cost is saved. More importantly, by adopting the spraying process to coat the packaging material on the surface of the substrate, the thickness of the packaging material layer can be accurately controlled. Hence, the thickness of the device after the packaging process can be dramatically decreased.

### Embodiment 2

In the second preferable embodiment, the packaging material is the mixture of the glass powder and metal oxide. The specific conditions for the packaging process have some differences with the first preferable embodiment.

The coating method of the packaging material of the second preferable embodiment comprises the following steps:

Determining a packaging area on a substrate, wherein the substrate may be a rigid substrate or flexible substrate, and preferably a rigid substrate, such as glass, metal, or other material selected according to the process or requirement.

Coating the packaging material on the packaging areas of the surface of the substrate, wherein, the coating process is effected by a melt spraying process comprising:

S1, heating and pressurizing the packaging material, i.e., the mixture of glass and metal oxide, in a reaction chamber; in this step, the temperature is controlled between 700° C. and 1600° C., such as 800° C., 900° C., 1000° C. and 1200° C.; the pressure is controlled between 0.2 MPa and 1.2 MPa, such as 0.3 MPa, 0.4 MPa, 0.6 MPa, 0.7 MPa and 0.8 MPa; the mixture of glass powder and metal oxide is transformed into the molten state from the solid state by the heating and the pressurization;

S2, supplying gas with the pressure between 0.2 MPa and 1.2 MPa, such as 0.3 MPa, 0.4 MPa, 0.6 MPa, 0.7 MPa and 0.8 MPa; with the aid of the pressure, the molten mixture is sprayed on the packaging area of the surface of the rigid substrate to form a rather thin and rather dense film of the packaging material; the thickness of the film can be selected between 3 μm and 6 μm, such as 4 μm and 5 μm.

In step of the melt spraying process, the metal oxide can be one or more selected from the group consisted of MgO, CaO, BaO, Li₂O, Na₂O, K₂O, B₂O₃, V₂O₅, ZnO, TeO₂, Al₂O₃, SiO₂, PbO, SnO, P₂O₅, Ru₂O, Fe₂O₃, Rb₂O, Rh₂O, CuO, TiO₂, WO₃, Bi₂O₃ and Sb₂O₃, more specifically, the metal oxide can be selected according to the actual manufacturing situations and process conditions.

After finishing the coating process of the packaging material, directing a cover plate at the packaging area of the substrate; bonding the cover plate and the substrate by the molten glass.

### Embodiment 3

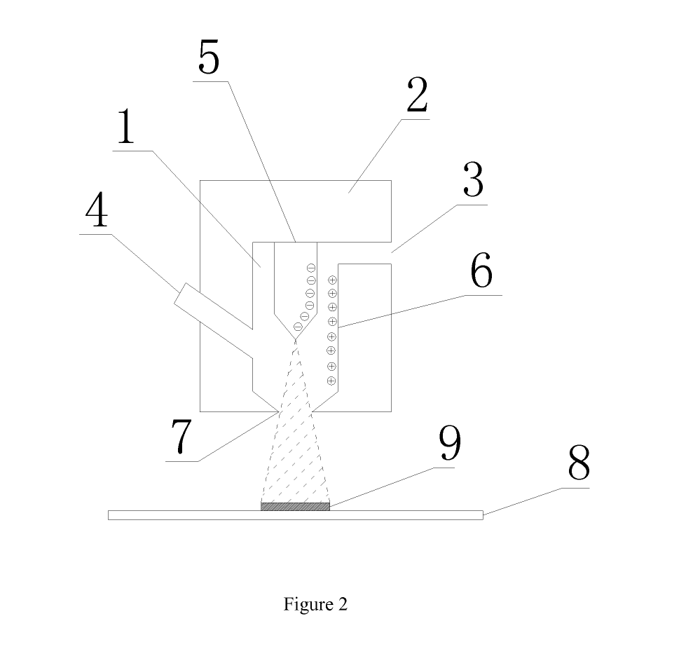

As shown in FIG. 2 which is a side view of the coating device which is used to perform the coating process to the surface of the substrate in the present embodiment, the coating device comprises:

a Reaction Chamber 1 with a feed inlet and a gas inlet;

a Cooling Chamber 2 clad outside Reaction Chamber 1 for cooling down Reaction Chamber 1, at the same time, isolating Reaction Chamber 1 with the external environment of the coating device.

The coating device can also comprise Gas Pipeline 3 placed in Cooling Chamber 2 and out of Reaction Chamber 1. Gas Pipeline 3 has an opening at each end respectively. One opening is connected to the gas inlet of Reaction Chamber 1, and the other opening is connected to the outside of the coating device. Through Gas Pipeline 3, the gas outside of the coating device can be carried into Reaction Chamber 1. In Gas Pipeline 3, a gas booster pump is provided, not shown in FIG. 2, for pressurizing the gas supplied into Reaction Chamber 1. Gas Pipeline 3 and the gas booster pump together form the pressurizing device of this embodiment to increase the pressure in Reaction Chamber 1.

The coating device can also comprise a Reactant Pipeline 4 for feeding the packaging material which is used in the coating process into Reaction Chamber 1. Reactant Pipeline 4 is placed out of Cooling Chamber 2 and Reaction Chamber 1. Reactant Pipeline 4 has an opening at each end respectively. One of the openings is connected to the feed inlet placed on Reaction Chamber 1, and the other opening is connected to the outside of the coating device. Through Reactant Pipeline 4, the packaging materials can be fed into Reaction Chamber 1.

The coating device can also comprise a heating device consisted of a Negative Electrode 5, a Positive Electrode 6, a Controller, not shown in FIG. 2, and an Electric Source, not shown in FIG. 2. Electric Source provides electronic current for Negative Electrode 5 and Positive Electrode 6 according to the controlling of the controller. When the electronic current is provided for Negative Electrode 5 and Positive Electrode 6 by the Electric Source, between the electronic current in Positive Electrode 6 and the electronic current in Negative Electrode 5, an electric arc is generated to increase the temperature in Reaction Chamber 1.

The coating device can also comprise a Nozzle 7 at the bottom thereof for spraying the melt packaging material from the reaction chamber. The size and the position of Nozzle 7 can be determined according to the actual process situation. Preferably, Nozzle 7 can be placed in the center of the bottom of the coating device. By changing the direction and shape of Nozzle 7, the spraying direction and spraying area of the melt packaging materials can be controlled.

The operation method of the coating device of this embodiment will be described in detail in the following content.

As shown in FIG. 2, when electronic current is provided, the electronic arc is generated between Negative Electrode 5 and Positive Electrode 6 in Reaction Chamber 1. Packaging material, such as the packaging material described in Embodiment 1 and Embodiment 2, is carried into Reaction Chamber 1 through Reactant Pipeline 4. At the high temperature resulting from the electronic arc in Reaction Chamber 1, the packaging material is transformed into molten state. Gas is supplied by Gas Pipeline 3 of the coating device, after being pressurized by the gas booster pump placed in Gas Pipeline 3, into Reaction Chamber 1 through the gas inlet on Reaction Chamber 1. Therefore, the pressure in Reaction Chamber 1 is increased, and, thus, the molten packaging material is sprayed out form Nozzle 7 of the coating device with the aid of the gas pressure, to coat on the areas which needs to be coated on the surface of Substrate 8. Finally, a dense Layer 9 of molten packaging material is formed on Substrate 8.

The coating device of the present invention is not limited in the application for the packaging process. It also can be applicable in the TFT process and Cover/Touch panel process.

In conclusion, the coating method applicable in the packaging process of the present invention can replace the process of coating, drying and sintering in the related art with one step. Therefore, the production circle of the packaging process is shortened dramatically and the production efficiency of actual manufacturing process can be improved. Furthermore, when coating the packaging materials by the coating device in the present invention, since the steps of drying and sintering are omitted, the number of the production apparatus in the whole packaging process is reduced, leading to the lower cost of equipment in the packaging process, as well as the lower cost of maintenance thereof.

While the present disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof

What claimed is:

1. A coating method of a packaging material, comprising:
providing a substrate with a packaging area;
transforming the packaging material into a molten state in the reaction chamber;
spraying the molten packaging material on the packaging area to form a layer of the packaging material on a surface of the packaging area;
wherein temperature of the packaging material sprayed on the substrate is lower than the melting point of the substrate.

2. The coating method as claimed in claim 1, wherein the step of transforming the packaging material into the molten state is performed by a heating step and a pressurizing step in the reaction chamber;
wherein, after the pressurizing step, pressure in the reaction chamber is between 0.2 MPa and 1.2 MPa.

3. The coating method as claimed in claim 1, wherein the packaging material is glass powder or a mixture consisted of glass and metal oxide.

4. The coating method as claimed in claim 3, when the packaging material is glass powder and the heating step is performed in the reaction chamber, the temperature in the reaction chamber is between 1800° C. and 2200° C.

5. The coating method as claimed in claim 3, when the packaging material is the mixture of glass and metal oxide and the heating step is performed in the reaction chamber, the temperature in the reaction chamber is between 700° C. and 1600° C.

6. The coating method as claimed in claim 3, wherein the metal oxide is one or more selected from a group consisted of MgO, CaO, BaO, Li₂O, Na₂O, K₂O, B₂O₃, V₂O₅, MO, TeO₂, Al₂O₃, SiO₂, PbO, SnO, P₂O₅, Ru₂O, Fe₂O₃, Rb₂O, Rh₂O, CuO, TiO₂, WO₃, Bi₂O₃ and Sb₂O₃.

7. The coating method as claimed in claim 1, wherein the thickness of the packaging material layer is between 3 μm and 6 μm.

8. The coating method as claimed in claim 1, wherein the substrate is a rigid substrate.

9. A coating device, comprising:
a reaction chamber for holding the packaging material;
a heating device for increasing the temperature of the environment in the reaction chamber; and
a pressurizing device for increasing the pressure of the environment in the reaction chamber;
wherein, the reaction chamber is provided with a nozzle to spray the molten packaging material formed by the environment changed by the heating device and the pressurizing device onto a substrate to form the packaging material layer.

10. The coating device as claimed in claim 9, wherein the reaction chamber comprises:
a feeding inlet for charging the packaging material into the reaction chamber; and
a gas inlet for carrying gas into the reaction chamber to increase the pressure with the aid of the pressurizing device, and the pressurizing device can be a gas booster pump.

11. The coating device as claimed in claim 9, wherein the heating device comprises:
a positive electrode and a negative electrode placed in the reaction chamber;
a controller; and
a electric source connected to the positive electrode and negative electrode by the controller to form a closed circuit;
wherein the electric source is controlled by the controller to provide electric current to form an electric arc between the positive electrode and negative electrode, by which the temperature in the reaction chamber is increased.
